(19) United States
(12) Patent Application Publication
(10) Pub. No.: US 2007/0121861 A1
(43) Pub. Date: May 31, 2007

(54) Main apparatus and communication terminal of a communication system

(75) Inventor: Yoshimitsu Ebisawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/604,266

(22) Filed: Nov. 27, 2006

(30) Foreign Application Priority Data
Nov. 29, 2005 (JP) P2005-344014

(51) Int. Cl. H04M 1/00

(52) U.S. Cl. 379/158

(57) ABSTRACT

According to one embodiment, a main apparatus of a communication system includes a storing unit that stores transmission times between each of a plurality of terminals and each of a plurality of conference apparatuses, to be associated with the plurality of terminals including a conference-holding terminal; a selecting unit that selects a conference apparatus among the plurality of conference apparatus which is least in the sum of the associated transmission times; and a notifying unit that notifies an conference ID of the selected conference apparatus to the plurality of terminals.

### CROSS-REFERENCE TO RELATED APPLICATIONS

This application is based upon and claims the benefit of priority from Japanese Patent Application No. 2005-344014, filed Nov. 29, 2005, the entire contents of which are incorporated herein by reference.

### BACKGROUND

1. Field

One embodiment of the invention relates to a system such as an IP (Internet protocol) telephone system which performs a speech communication between telephone terminals via an IP network. In particular, the invention relates to a main apparatus and a conferencing connection method of a communication system which allows conferencing calls between telephone terminals connected to an IP network.

2. Description of the Related Art

In recent years, network telephone systems (IP telephone systems) in which packet data of images and voices are exchanged bidirectionally in real time via a packet communication network have started to spread. In these IP telephone systems, speech communications can be performed across the border of countries or regions via a packet communication network, not to mention speech communications can be performed between IP telephone terminals connected to a packet communication network and between an IP telephone terminal and a telephone terminal connected to a public network.

In the above IP telephone systems, a service has been proposed in which speakers at other IP telephone terminals are convened from a particular IP telephone terminal and conferencing calls of three or more parties are performed (e.g., JP-A-6-237303).

Incidentally, in the above IP telephone systems, when conferencing calls are performed, voices of speakers are combined by a conferencing circuit of a connection apparatus and each speaker hears resulting voices. This conferencing circuit is a fixed one that is predetermined irrespective of the network state, for example, the conferencing circuit in a connection apparatus incorporating a conference-hosting terminal.

However, with this manner of use of an IP telephone system, the transmission time may become long depending on the traffic volume of the network and the arrangement of conference speakers.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram showing the configuration of an IP telephone system according to a first embodiment.

FIG. 2 is a block diagram showing the functional configuration of a main apparatus shown in FIG. 1.

FIG. 3 shows exemplary storage contents of a database of the main apparatus according to the first embodiment.

FIG. 4 is a sequence diagram showing operations of information exchanges between IP terminals, conferencing circuits, and the main apparatus in a case that the IP terminals succeed in connecting to an optimum conferencing circuit in the first embodiment.

FIG. 5 is a flowchart showing a process that is executed by the main apparatus according to the first embodiment.

FIGS. 6A and 6B are tables showing section-by-section transmission times of transmissions between the IP terminals via each conferencing circuit which are calculated by the main apparatus in the first embodiment.

FIGS. 7A and 7B are tables showing transmission times of transmissions between the IP terminals for each conferencing circuit which are calculated by the main apparatus in the first embodiment.

FIG. 8 is a sequence diagram showing operations of information exchanges between the IP terminals, the conferencing circuits, and the main apparatus in a case that not all the IP terminals succeed in connecting to the optimum conferencing circuit in the first embodiment of the invention.

FIG. 9 is a sequence diagram showing operations of information exchanges between IP terminals in a case that the IP terminals succeed in connecting to an optimum conferencing circuit in an IP terminal in a second embodiment.

FIG. 10 shows exemplary storage contents of a database of the main apparatus according to the second embodiment.

FIGS. 11A-C are tables showing transmission times of transmissions between the IP terminals for each IP terminal which are calculated by the main apparatus in the second embodiment.

### DETAILED DESCRIPTION

Various embodiments according to the invention will be described hereinafter with reference to the accompanying drawings. In general, according to one embodiment of the invention, a main apparatus of a communication system, wherein the communication system is connected to a communication network for transmitting communication packets and includes a first terminal, a second terminal and a third terminal, each having a terminal ID, and the communication system connects the first terminal, the second terminal and the third terminal to one of a first conference apparatus and a second conference apparatus, each connected to the communication system and having a conference ID, the main apparatus a notifying unit that selects an optimum conference apparatus from the first conference apparatus and the second conference apparatus according to a predetermined condition and notifies the conference ID of the optimum conference apparatus to the first terminal, the second terminal and the third terminal; and a control unit that performs a connection processing of the first terminal, the second terminal, and the third terminal to the optimum conference apparatus on receiving conference connection requests from the first terminal, the second terminal, and the third terminal in response to the notification of the conference ID of the optimum conference apparatus.

Embodiments of the present invention will be hereinafter described in detail with reference to the drawings.

### First Embodiment

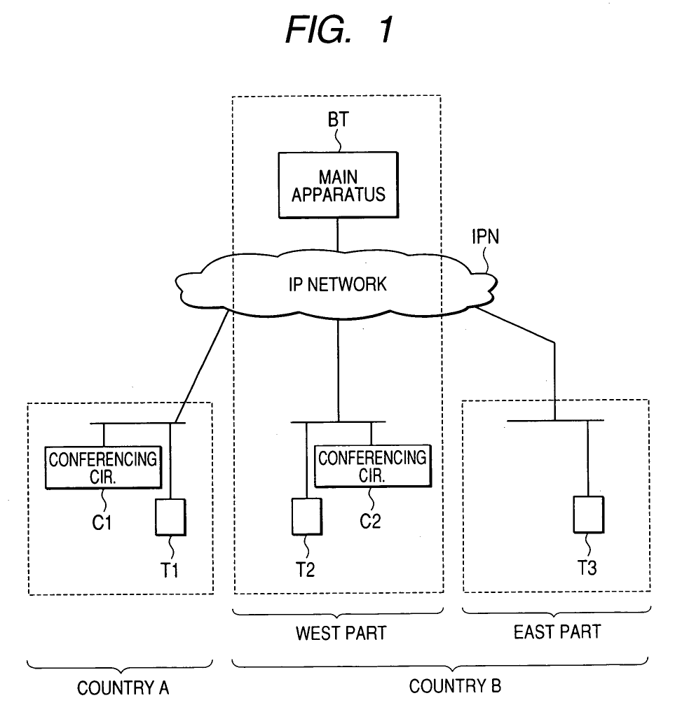

FIG. 1 is a schematic diagram showing the configuration of an IP telephone system according to a first embodiment of the invention.

This system has a packet communication IP network IPN consisting of the Internet and LANs (local area networks). The IP network IPN covers country A, a west part of country B, and an east part of country B, and is connected to an IP terminal Ti in country A, an IP terminal T2 in the west part of country B, and an IP terminal T3 in the east part of country B. Each of the IP terminals T1, T2, and T3 has a communication processing function and a media information processing function.

Conferencing circuits C1 and C2 are also connected to the IP network IPN, and serve for conferencing connections between the IP terminals T1, T2, and T3. The IP terminals T1, T2, and T3 and the conferencing circuits C1 and C2 are connected to a main apparatus BT via the IP network IPN. It is assumed that the main apparatus BT is installed in the west part of country B.

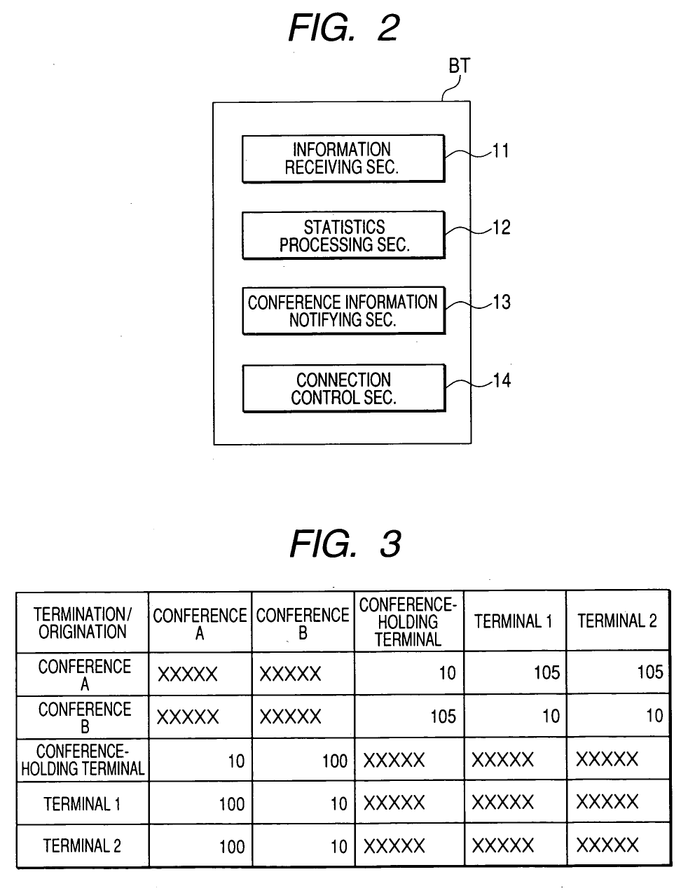

FIG. 2 is a block diagram showing the functional configuration of the main apparatus BT.

The main apparatus BT has, in addition to a switching function for the IP terminals T1, T2, and T3 and the conferencing circuits C1 and C2, an information receiving section 11, a statistics processing section 12, a conference information notifying section 13, and a connection control section 14.

The information receiving section 11 receives, from the IP terminals T1, T2, and T3 and the conferencing circuits C1 and C2, measurement results of transmission times of communication packet transmissions between the IP terminals T1, T2, and T3 and between each of the IP terminals T1, T2, and T3 and each of the conferencing circuits C1 and C2, and stores the measurement results in a database in such a manner that they are correlated with terminal IDs (conference-holding terminal, terminal-1, and terminal-2) of the respective IP terminals T1, T2, and T3 and conference IDs (conference-A and conference-B) of the respective conferencing circuits C1 and C2. FIG. 3 shows exemplary storage contents of the database.

Based on the measurement results accumulated in the database, the statistics processing section 12 calculates transmission times of transmissions between the IP terminals T1, T2, and T3 via each of the conferencing circuits C1 and C2 and an average of transmission times of transmissions between the IP terminals T1, T2, and T3 for each of the conferencing circuits C1 and C2.

The conference information notifying section 13 chooses an optimum conferencing circuit C2 on the basis of the average times calculated by the statistics processing section 12, and communicates conferencing circuit information including the conference ID of the conferencing circuit C2 to the IP terminals T1, T2, and T3.

When conferencing connection requests including the conference ID of the conferencing circuit C2 come from the IP terminals T1, T2, and T3 in response to the conferencing circuit information the connection control section 14 performs processing of connecting the IP terminals T1, T2, and T3 to the conferencing circuit C2.

Next, the operation of the above-configured IP telephone system will be described.

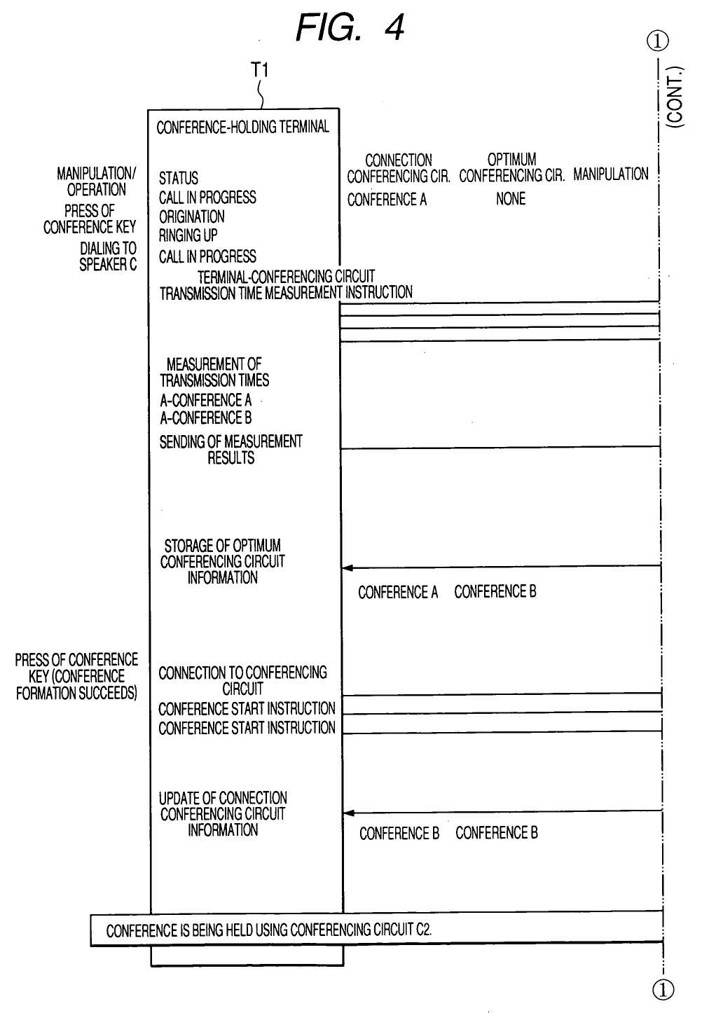

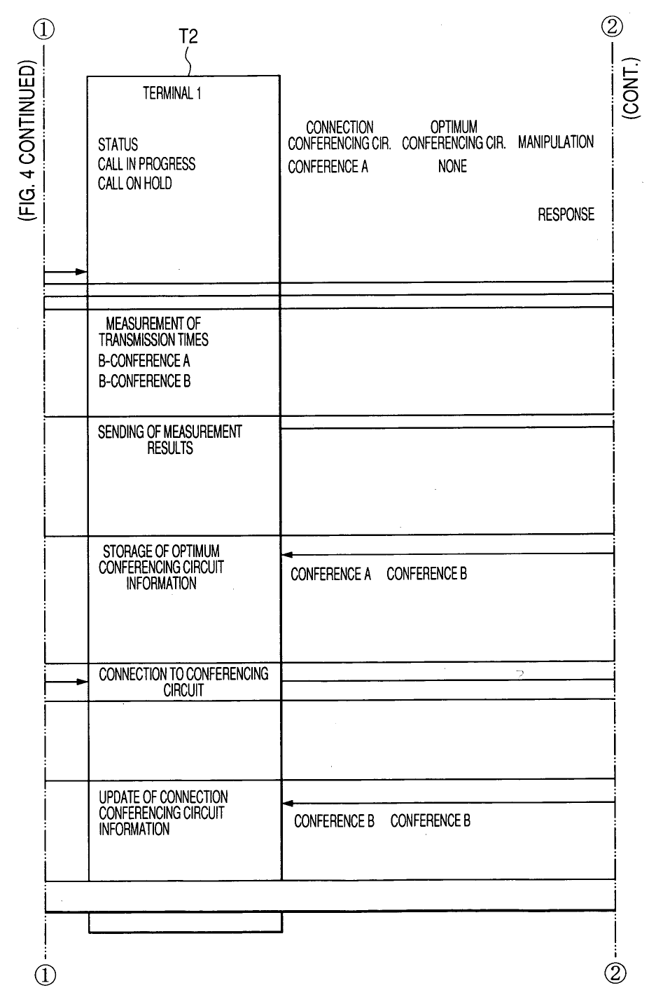

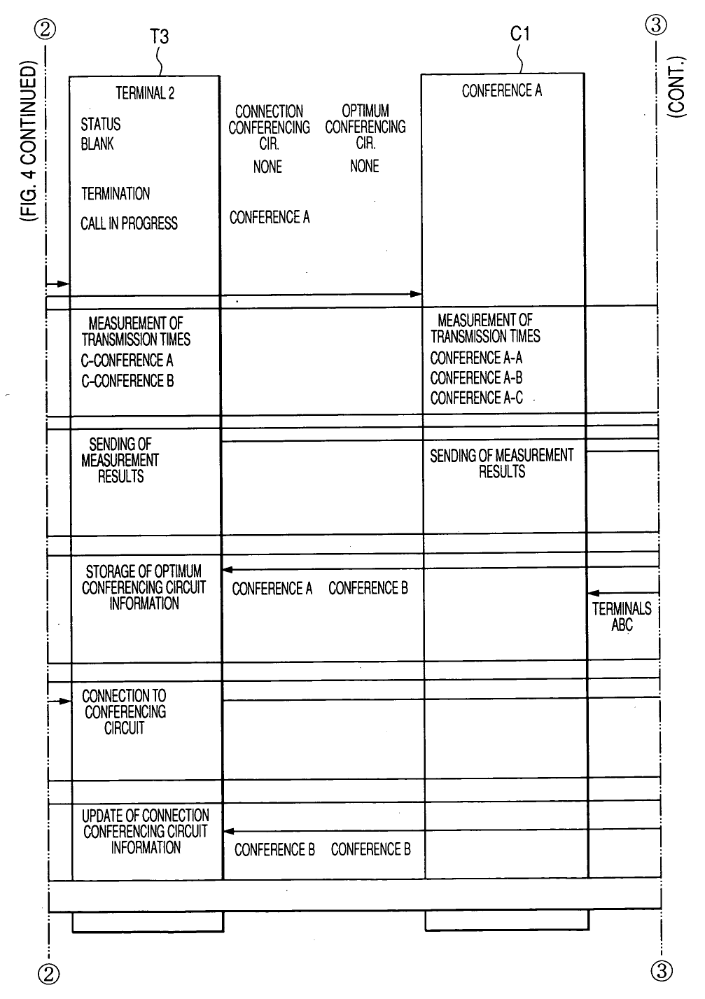

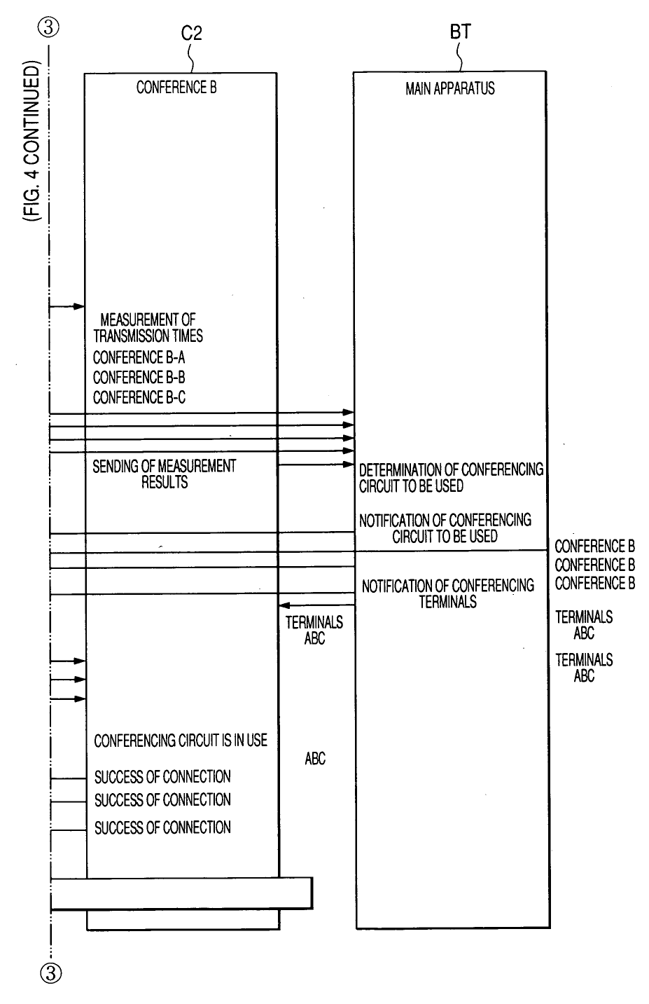

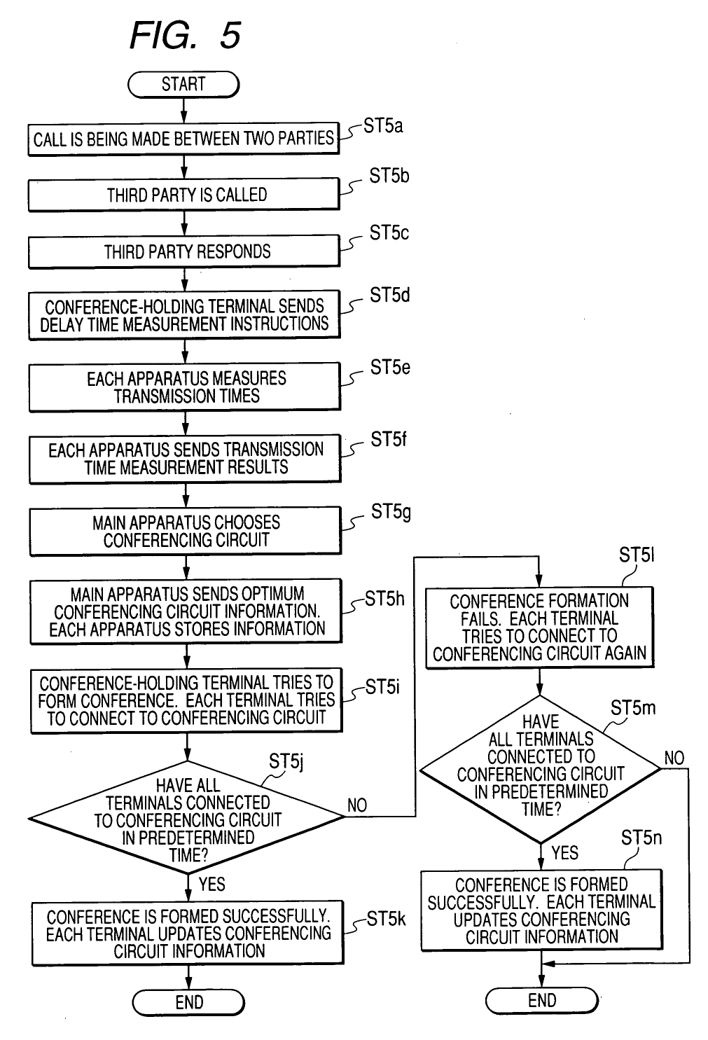

FIG. 4 is a sequence diagram showing operations of information exchanges between the IP terminals T1, T2, and T3, the conferencing circuits C1 and C2, and the main apparatus BT in a case that the IP terminals T1, T2, and T3 succeed in connecting to the optimum conferencing circuit C2. FIG. 5 is a flowchart showing a process executed by the main apparatus BT.

First, assume that a call is being made between the IP terminals T1 and T2. Also assume that in this state the user of the IP terminal T1, for example, performs a manipulation for causing the IP terminal T3 to participate in conferencing calls. In response, the IP terminal T1 sends related request information to the main apparatus BT.

Receiving the request information, the main apparatus BT moves from step ST5a to step ST5b. At step ST5b, while maintaining the communication link between the IP terminals T1 and T2, the main apparatus BT sends request information to the IP terminal T3 via the IP network IPN and causes a call alert in the form of a beep sound or an incoming call display. If the user performs a responsive manipulation in response to the call alert, the IP terminal T3 sends a connection response signal to the main apparatus BT.

Receiving the connection response signal, at step ST5c the main apparatus BT connects the IP terminals T1, T2, and T3 to the conferencing circuit C1 which is installed in country A.

When terminal-conferencing circuit transmission time measurement instructions are sent from the conference-holding IP terminal T1 to the IP terminals T2 and T3 and the usable conferencing circuits C1 and C2 at step ST5d, at step ST5e the IP terminals T2 and T3 and the conferencing circuits C1 and C2 measure terminal-conferencing circuit communication packet transmission times. At this time, the IP terminal T1 also measures terminal-conferencing circuit communication packet transmission times.

The IP terminals T1, T2 and T3 and the conferencing circuits C1 and C2 send measurement results to the main apparatus BT. Receiving the measurement results, the main apparatus BT moves from step ST5f to step ST5g, where the main apparatus BT stores the measurement results in the database.

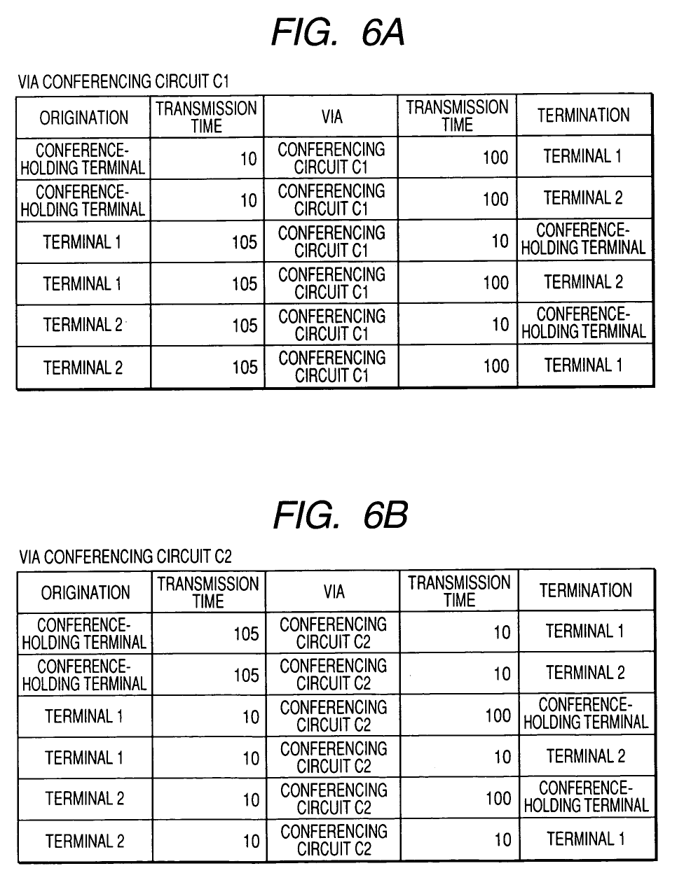

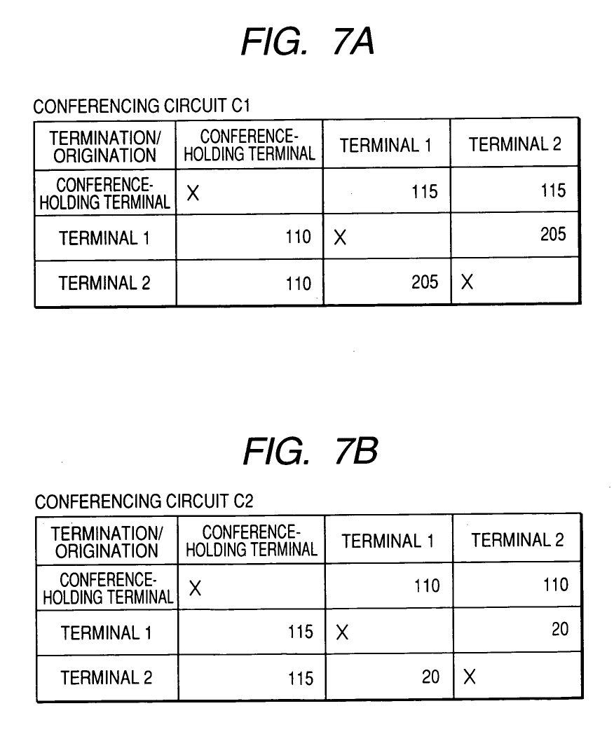

Based on the measurement results, the main apparatus BT calculates section-by-section transmission times of transmissions between the IP terminals T1, T2, and T3 via each of the conferencing circuits C1 and C2 (see FIGS. 6A and 6B) and arranges transmission times of transmissions between the IP terminals T1, T2, and T3 for each of the conferencing circuits C1 and C2 (see FIGS. 7A and 7B). Then, an average of the transmission times is calculated for each of the conferencing circuits C1 and C2. An average for the conferencing circuit C1 is calculated as (115+115+110+205+110+205)/6=143.3333 ms. On the other hand, an average for the conferencing circuit C2 is calculated as (110+110+115+20+115+20)/6=81.66667 ms. Therefore, it is determined that the conferencing circuit C2 is an optimum one.

At step ST5h, the main apparatus BT communicates conferencing circuit information including the conference ID (conference-B) of the conferencing circuit C2 to the IP terminals T1, T2, and T3. The IP terminals T1, T2, and T3 store therein the conferencing circuit information including the conference ID (conference-B).

Assume that in this state the user of the IP terminal T1 performs a manipulation for requesting conferencing connections to the conferencing circuit C2. In response, the IP terminal T1 sends related request information to the main apparatus BT and sends conference start instructions to the IP terminals T2 and T3. Receiving the request information, the main apparatus BT moves from step ST5i to step ST5j, where the main apparatus BT judges whether each of the IP terminals T1, T2, and T3 has connected to the conferencing circuit C2 in a predetermined time.

If each of the IP terminals T1, T2, and T3 has connected to the conferencing circuit C2 in the predetermined time, the main apparatus BT moves from step ST5j to step ST5k, where the main apparatus BT causes the conferencing circuit C2 to instruct the IP terminals T1, T2, and T3 to update the conferencing circuit information.

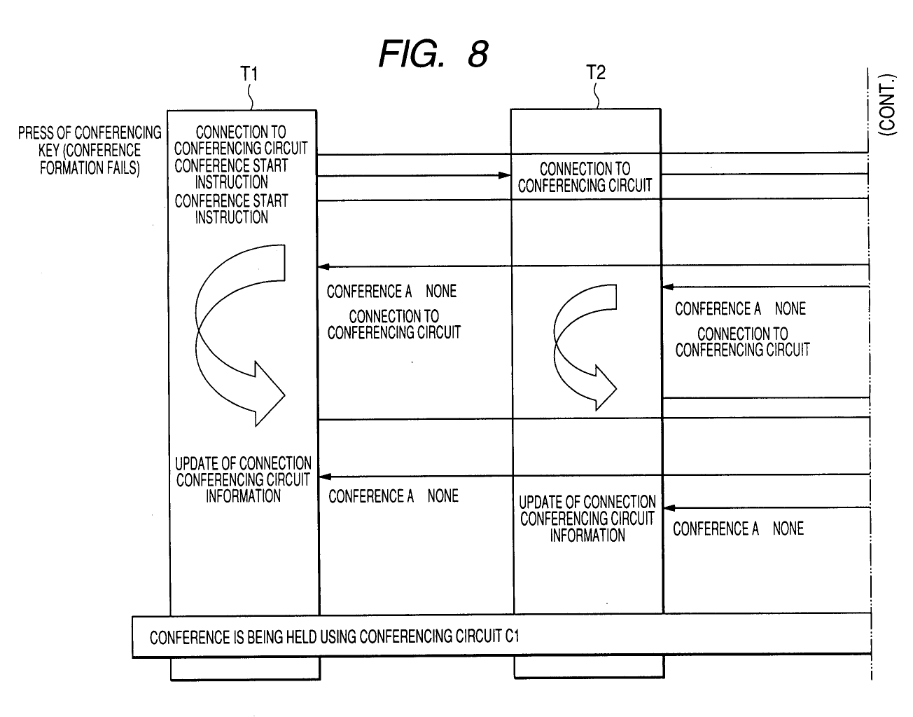

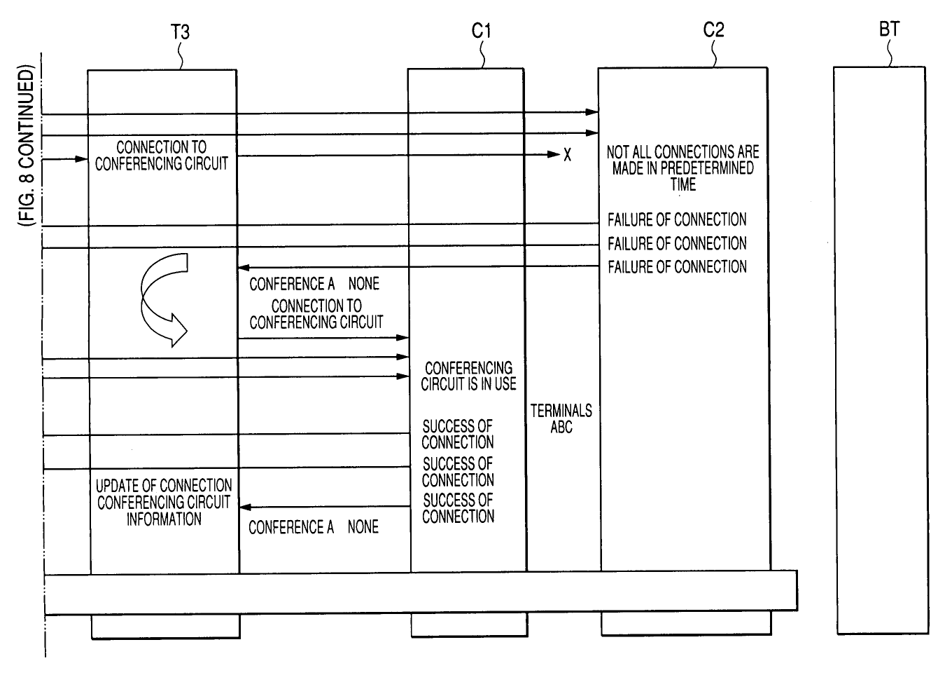

FIG. 8 is a sequence diagram showing operations of information exchanges between the IP terminals T1, T2, and T3, the conferencing circuits C1 and C2, and the main apparatus BT in a case that not all the IP terminals T1, T2, and T3 succeed in connecting to the optimum conferencing circuit C2.

If judging at step ST5j that not all the IP terminals T1, T2, and T3 have connected to the conferencing circuit C2 in the predetermined time, at step ST5l the main apparatus BT instructs each of the IP terminals T1, T2, and T3 to try to connect to the conferencing circuit C1. At step ST5m, the main apparatus BT judges whether each of the IP terminals T1, T2, and T3 has connected to the conferencing circuit C1 in a predetermined time.

If each of the IP terminals T1, T2, and T3 has connected to the conferencing circuit C1 in the predetermined time, the main apparatus BT moves from step ST5m to step ST5n, where the main apparatus BT causes the conferencing circuit C1 to instruct the IP terminals T1, T2, and T3 to update the conferencing circuit information.

On the other hand, if not all the IP terminals T1, T2, and T3 have connected to the conferencing circuit C1 in the predetermined time, the main apparatus BT finishes the process without execution of any further steps.

From this time onward, every time it is attempted to add a new speaker terminal, transmission times of transmissions from the new speaker terminal to the conferencing circuits C1 and C2 and transmissions from the conferencing circuits C1 and C2 to the new speaker terminal are measured and measurement results are transmitted to the main apparatus BT. Based on the received data, the main apparatus BT determines a conferencing circuit C2 that is most suitable for the current network situation and designates it as a conferencing circuit to which connections should be made in starting a conference. In forming a conference, each of the IP terminals T1, T2, and T3 tries to connect to the pre-designated conferencing circuit C2.

It is also possible to start measurements at an arbitrary time point, informs each speaker terminal of a conferencing circuit C1 or C2 that is most suitable for a network situation at that time point, and switch the conferencing circuit employed at an arbitrary time point.

As described above, according to the first embodiment, the main apparatus BT calculates transmission times of communication packet transmissions between the IP terminals T1, T2, and T3 for each of the conferencing circuits C1 and C2 in a state that the IP terminals T1, T2, and T3 are conferencing-connected to the conferencing circuit C1. The main apparatus BT chooses (designates) an optimum conferencing circuit C2 on the basis of calculation results. Then, the main apparatus BT communicates conferencing circuit information including the conference ID of the conferencing circuit C2 to the IP terminals T1, T2, and T3 and thereby causes switching so that the IP terminals T1, T2, and T3 are connected to the conferencing circuit C2 instead of the conferencing circuit C1.

This enables optimum conferencing calls between the IP terminals T1, T2, and T3 on the IP network IPN even in an environment that the communication packet transmission times vary.

### Second Embodiment

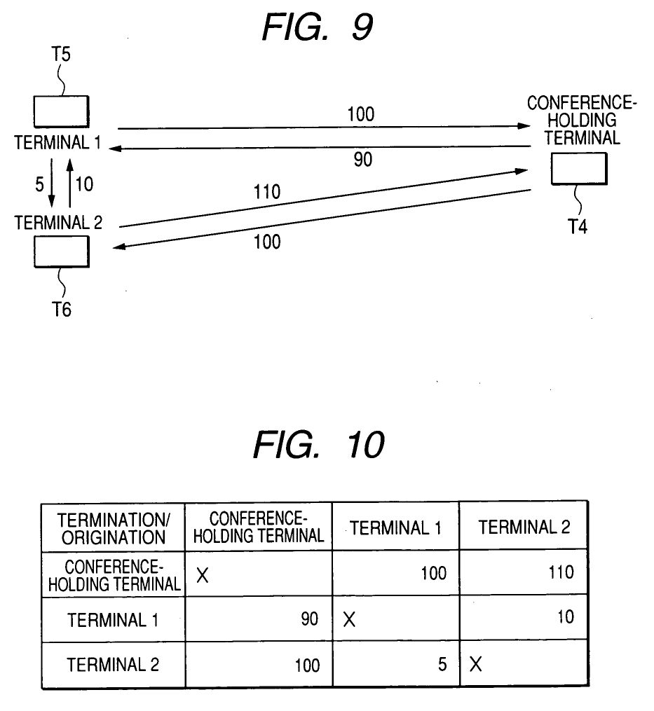

FIG. 9 is a sequence diagram showing operations of information exchanges between IP terminals T4, T5, and T6 in a case that the IP terminals T4, T5, and T6 succeed in connecting to an optimum conferencing circuit in an IP terminal.

First, assume that a call is being made between the IP terminals T4 and T5. Also assume that in this state the user of the IP terminal T4, for example, performs a manipulation for causing the IP terminal T6 to participate in conferencing calls. In response, the IP terminal T4 sends related request information to the main apparatus BT.

Receiving the request information, the main apparatus BT sends request information to the IP terminal T6 via the IP network IPN and causes a call alert in the form of a beep sound or an incoming call display while maintaining the communication link between the IP terminals T4 and T5. If the user performs a responsive manipulation in response to the call alert, the IP terminal T6 sends a connection response signal to the main apparatus BT.

Receiving the connection response signal, the main apparatus BT connects the IP terminals T5 and T6 to the conferencing circuit in the IP terminal T4.

When inter-terminal transmission time measurement instructions are sent from the conference-holding IP terminal T4 to the IP terminals T5 and T6, the IP terminals T5 and T6 measure inter-terminal communication packet transmission times. At this time, the IP terminal T4 also measures inter-terminal communication packet transmission times.

The IP terminals T4, T5, and T6 send measurement results to the main apparatus BT. Receiving the measurement results, the main apparatus BT stores the measurement results in a database. FIG. 10 shows exemplary storage contents of the database.

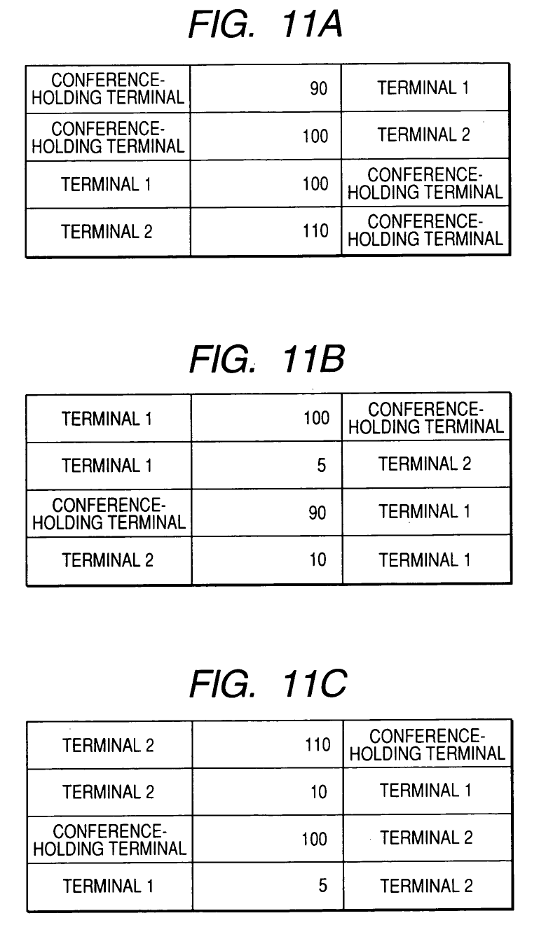

Based on the measurement results, the main apparatus BT arranges transmission times of transmissions between the IP terminals T4, T5, and T6 for the conference-holding IP terminal T4 (see FIG. 11A), for the IP terminal T5 as terminal-1 (see FIG. 11B), and for the UP terminal T6 as terminal-2 (see FIG. 11C).

Then, an average of the transmission times is calculated for each of the IP terminals T4, T5, and T6. An average for the IP terminal T4 is calculated as (90+100+100+110)/4=100 ms. An average for the IP terminal T5 is calculated as (100+5+90+10)/4=51.25 ms. An average for the IP terminal T6 is calculated as (110+10+100+5)/4=56.25 ms. Therefore, it is determined that the conferencing circuit of the IP terminal T5 is an optimum one.

Then, the main apparatus BT communicates conferencing circuit information including the conference ID of the conferencing circuit of the IP terminal T5 to the IP terminals T4, T5, and T6. The IP terminals T4, T5, and T6 store the conferencing circuit information therein.

Assume that in this state the user of the IP terminal T4 performs a manipulation for requesting conferencing connections to the conferencing circuit of the IP terminal T5. In response, the IP terminal T4 sends related request information to the main apparatus BT and sends conference start instructions to the IP terminals T5 and T6. Receiving the request information, the main apparatus BT judges whether each of the IP terminals T4, T5, and T6 has connected to the conferencing circuit of the IP terminal T5 in a predetermined time.

If each of the IP terminals T4, T5, and T6 has connected to the conferencing circuit of the IP terminal T5 in the predetermined time, the main apparatus BT causes the conferencing circuit of the IP terminal T5 to instruct the IP terminals T4, T5, and T6 to update the conferencing circuit information.

On the other hand, if not all the IP terminals T4, T5, and T6 have connected to the conferencing circuit of the IP terminal T5 in the predetermined time, the main apparatus BT instructs each of the IP terminals T4, T5, and T6 to try to connect to the conferencing circuit of the IP terminal T4. If each of the IP terminals T4, T5, and T6 has connected to the conferencing circuit of the IP terminal T4 in a predetermined time, the main apparatus BT causes the conferencing circuit of the IP terminal T4 to instruct the IP terminals T4, T5, and T6 to update the conferencing circuit information.

The above-described second embodiment provides the same advantages as the first embodiment does. In addition, the second embodiment can make the processing load lighter than in the first embodiment because transmission times of communication packet transmissions between each of the IP terminals T4, T5, and T6 and each of the conferencing circuits are not taken into consideration.

### Other Embodiments

The invention is not limited to the above embodiments. Since there are such networks as ADSL networks in which communication rates are asymmetrical, in the above embodiments both of outward transmission times and return transmission times are measured. However, where it is desired to shorten the judgment time or it is known that there are no components that cause asymmetrical transmission rates, a judgment may be made by measuring only outward or return packet transmission times.

Although in the first and second embodiments a connection apparatus that minimizes the packet transmission distances from the terminals is determined, a connection apparatus that minimizes the packet transmission distance between particular speaker terminals may be determined.

Although in the first and second embodiments transmission times are measured in forming a conference, a configuration is possible in which transmission times are measured regularly even after formation of a conference and the optimum conferencing circuit is changed one after another during the conference in accordance with the network situation.

Although the first and second embodiments are directed to the case that an optimum conferencing circuit is chosen (designated) according to a condition using the transmission times, an optimum conferencing circuit may be chosen (designated) according to a condition using the type of network such as the wireless LAN or ADSL instead of the transmission times. In this configuration, the database as shown in FIG. 3 may include fixed value of transmission times, which are previously determined according to the type of network. Such configuration allows the IP terminals to omit the detection of transmission times, so that the choice of the optimum conferencing circuit is made easier. Furthermore, the number of IP terminals involved of each country may be used as an element of a condition.

The application range of the invention is not limited to oral conferences but encompasses video conferences, because an optimum conferencing circuit is chosen by utilizing times taken by transmissions between apparatus.

Other various modifications are possible without departing from the spirit and scope of the invention in terms of the configuration and type of system, the configuration and type of main apparatus, the type of terminal, the storage contents of the database, the conferencing circuit selection control method, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A main apparatus of a communication system, wherein the communication system is connected to a communication network for transmitting communication packets and includes a first terminal, a second terminal and a third terminal, each having a terminal ID, and the communication system connects the first terminal, the second terminal and the third terminal to one of a first conference apparatus and a second conference apparatus, each connected to the communication system and having a conference ID, the main apparatus comprising:
a notifying unit that selects an optimum conference apparatus from the first conference apparatus and the second conference apparatus according to a predetermined condition and notifies the conference ID of the optimum conference apparatus to the first terminal, the second terminal and the third terminal; and
a control unit that performs a connection processing of the first terminal, the second terminal, and the third terminal to the optimum conference apparatus on receiving conference connection requests from the first terminal, the second terminal, and the third terminal in response to the notification of the conference ID of the optimum conference apparatus.

2. The main apparatus according to claim 1,
wherein the notifying unit determines the predetermined condition according to transmission times of the communication packets between each of the first terminal, the second terminal and the third terminal, and each of the first conference apparatus and the second conference apparatus.

3. The main apparatus according to claim 1,
wherein the notifying unit determines the predetermined condition according to a type of the communication network.

4. The main apparatus according to claim 1,
wherein the control unit connects the first terminal, the second terminal, and the third terminal to a conference apparatus other than the optimum conference apparatus when a connection of at least one of the first terminal, the second terminal, and the third terminal to the optimum conference apparatus is not completed in a predetermined time.

5. The main apparatus according to claim 2,
wherein the transmission times are respectively detected by the first terminal, the second terminal and the third terminal and sent to the notifying unit.

6. The main apparatus according to claim 2,
wherein the notifying unit selects the optimum conference apparatus which realizes a least sum of the transmission times.

7. A main apparatus of a communication system, comprising:
a storing unit that stores transmission times between each of a plurality of terminals and each of a plurality of conference apparatuses, to be associated with the plurality of terminals including a conference-holding terminal;
a selecting unit that selects a conference apparatus among the plurality of conference apparatus which is least in the sum of the associated transmission times; and
a notifying unit that notifies an conference ID of the selected conference apparatus to the plurality of terminals.

8. The main apparatus according to claim 7,
wherein the selecting unit selects the conference apparatus which is least in a sum of the associated transmission times regardless of a distance between the conference-holding terminal and the conference apparatus.

9. The main apparatus according to claim 7,
wherein the selecting unit selects the conference apparatus which is least in a sum of the associated transmission times regardless of whether the conference-holding terminal contains one of the plurality of terminals.

10. The main apparatus according to claim 7
wherein the storing unit stores a predetermined input value as at least one of the transmission times.

11. The main apparatus according to claim 10
wherein the predetermined input value is determined according to a type of a communication network.

12. A communication terminal, comprising:
a terminal unit that is connected to a communication system; and
a conference circuit;
wherein the terminal unit sends to an external communication terminal an instruction for connecting to an external conference circuit that is designated by a main apparatus.

13. The communication terminal according to claim 12,
wherein the terminal unit sends to the external communication terminal an instruction for connecting to the conference circuit when at least one of the terminal unit and the external terminal does not complete a connection to the external conference circuit within a predetermined time.
